(19) United States
(12) Patent Application Publication
(10) Pub. No.: US 2012/0202569 A1
(43) Pub. Date: Aug. 9, 2012

(54) Three-Dimensional User Interface for Game Applications

(75) Inventors: Aviad Maizels, Ramat Ha-Sharon (IL); Ziv Hendel, Herzliya (IL); Tamir Berliner, Beit Hashmonay (IL)

(73) Assignee: PRIMESENSE LTD., Tel Aviv (IL)

(21) Appl. No.: 13/423,322

(22) Filed: Mar. 19, 2012

Related U.S. Application Data
(63) Continuation-in-part of application No. 12/352,622, filed on Jan. 13, 2009, now Pat. No. 8,166,421.
(60) Provisional application No. 61/538,867, filed on Sep. 25, 2011.

(51) Int. Cl. A63F 13/00; G06F 17/00

(52) U.S. Cl. 463/3; 463/2; 463/43

(57) ABSTRACT

A method, including defining an interaction surface containing an interaction region in space, capturing a sequence of depth maps over time of at least a part of a body of a human subject, and processing the depth maps in order to detect a direction and speed of movement of the part of the body as the part of the body passes through the interaction region. A software application, selected from a group of software applications consisting of a flight simulation and an interactive tennis game, is controlled responsively to the detected direction and speed.

### CROSS-REFERENCE TO RELATED APPLICATIONS

This application is a continuation-in-part of U.S. patent application Ser. No. 12/352,622, filed Jan. 13, 2009, which is incorporated herein by reference. This application claims the benefit of U.S. Provisional Patent Application 61/538,867, filed Sep. 25, 2011, which is incorporated herein by reference. This application is related to another U.S. patent application, filed on even date, entitled, “Gesture-Based User Interface” (attorney docket number 1020-1013.1).

### FIELD OF THE INVENTION

The present invention relates generally to user interfaces for computerized systems, and specifically to user interfaces that are based on three-dimensional sensing.

### BACKGROUND OF THE INVENTION

Many different types of user interface devices and methods are currently available. Common tactile interface devices include the computer keyboard, mouse and joystick. Touch screens detect the presence and location of a touch by a finger or other object within the display area. Infrared remote controls are widely used, and “wearable” hardware devices have been developed, as well, for purposes of remote control.

Computer interfaces based on three-dimensional (3D) sensing of parts of the user's body have also been proposed. For example, PCT International Publication WO 03/071410, whose disclosure is incorporated herein by reference, describes a gesture recognition system using depth-perceptive sensors. A 3D sensor provides position information, which is used to identify gestures created by a body part of interest. The gestures are recognized based on the shape of the body part and its position and orientation over an interval. The gesture is classified for determining an input into a related electronic device.

Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

As another example, U.S. Pat. No. 7,348,963, whose disclosure is incorporated herein by reference, describes an interactive video display system, in which a display screen displays a visual image, and a camera captures 3D information regarding an object in an interactive area located in front of the display screen. A computer system directs the display screen to change the visual image in response to the object.

### SUMMARY OF THE INVENTION

Embodiments of the present invention that are described hereinbelow provide improved methods and systems for user interaction with a computer system based on 3D sensing of parts of the user's body. In some of these embodiments, the combination of 3D sensing with a visual display creates a sort of “touchless touch screen,” enabling the user to select and control application objects appearing on the display without actually touching the display.

There is provided, in accordance with an embodiment of the present invention a method, including defining an interaction surface containing an interaction region in space, capturing a sequence of depth maps over time of at least a part of a body of a human subject, processing the depth maps in order to detect a direction and speed of movement of the part of the body as the part of the body passes through the interaction region, and controlling a software application, selected from a group of software applications consisting of a flight simulation and an interactive tennis game, responsively to the detected direction and speed.

There is also provided, in accordance with an embodiment of the present invention an apparatus, including a display, and a computer coupled to the display and configured to define an interaction surface containing an interaction region in space, to capture a sequence of depth maps over time of at least a part of a body of a human subject, to process the depth maps in order to detect a direction and speed of movement of the part of the body as the part of the body passes through the interaction region, and to control a software application, selected from a group of software applications consisting of a flight simulation and an interactive tennis game, responsively to the detected direction and speed.

There is further provided, in accordance with an embodiment of the present invention a computer software product, including a non-transitory computer-readable medium, in which program instructions are stored, which instructions, when read by a computer, cause the computer to define an interaction surface containing an interaction region in space, to capture a sequence of depth maps over time of at least a part of a body of a human subject, to process the depth maps in order to detect a direction and speed of movement of the part of the body as the part of the body passes through the interaction region, and to control a software application, selected from a group of software applications consisting of a flight simulation and an interactive tennis game, responsively to the detected direction and speed.

### BRIEF DESCRIPTION OF THE DRAWINGS

The present invention will be more fully understood from the following detailed description of the embodiments thereof, taken together with the drawings in which:

FIG. 1 is a schematic, pictorial illustration of a 3D user interface for a computer system, in accordance with an embodiment of the present invention;

FIG. 2 is a block diagram that schematically illustrates functional components of a 3D user interface, in accordance with an embodiment of the present invention;

FIG. 3 is a schematic, pictorial illustration showing visualization and interaction regions associated with a 3D user interface, in accordance with an embodiment of the present invention;

FIG. 4 is a flow chart that schematically illustrates a method for operating a 3D user interface, in accordance with an embodiment of the present invention;

FIG. 5 is a schematic representation of a computer display screen, showing images created on the screen in accordance with an embodiment of the present invention;

FIGS. 6A and 6B are schematic pictorial illustrations of a user's hand performing a Grab gesture, in accordance with an embodiment of the present invention;

FIG. 6C is a schematic pictorial illustration of the user's hand performing a Release gesture, in accordance with an embodiment of the present invention;

FIG. 7 is a schematic pictorial illustration of a user performing a Pull gesture and a Push gesture, in accordance with an embodiment of the present invention; and

FIGS. 8A and 8B, are schematic pictorial illustrations of the user moving a palm of a hand in circular motions, in accordance with an embodiment of the present invention.

### DETAILED DESCRIPTION OF EMBODIMENTS

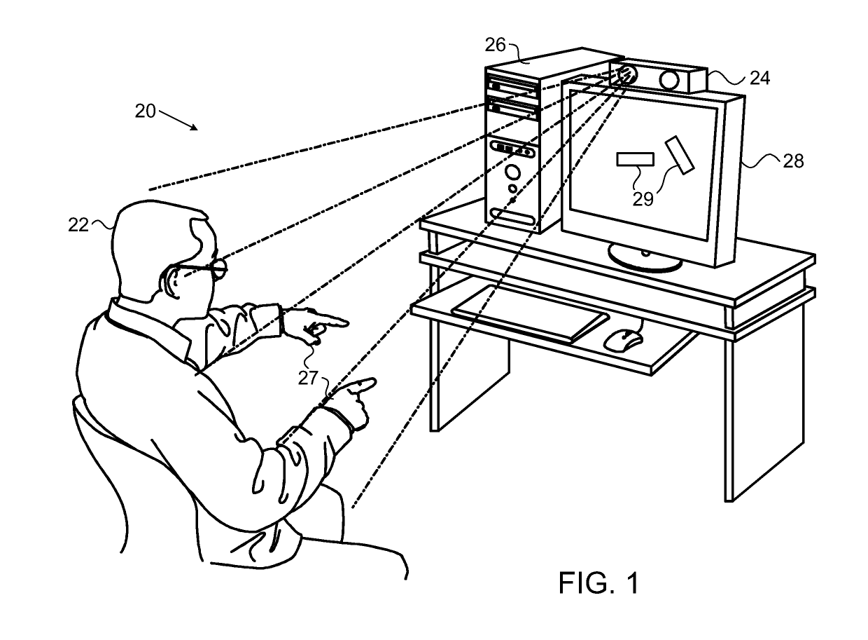

FIG. 1 is a schematic, pictorial illustration of a 3D user interface 20 for operation by a user 22 of a computer 26, in accordance with an embodiment of the present invention. The user interface is based on a 3D sensing device 24, which captures 3D scene information that includes the body, or at least parts of the body of the user, such as hands 27. Device 24 or a separate camera (not shown in the figures) may also capture video images of the scene. The information captured by device 24 is processed by computer 26, which drives a display screen 28 so as to present and manipulate application objects 29.

While the configuration of 3D sensing device 24 shown in FIG. 1 comprises a 3D sensing device, other optical sensing devices are considered to be within the spirit and scope of the present invention. For example, sensing device 24 may comprise a two-dimensional (2D) optical sensor configured to capture 2D images. Alternatively, sensing device 24 may comprise multiple 2D optical sensors configured to capture multiple 2D images simultaneously (wherein the simultaneously captured 2D images can be analyzed to identify 3D motion).

Computer 26 processes data generated by device 24 in order to reconstruct a 3D map of user 22. The term “3D map” refers to a set of 3D coordinates representing the surface of a given object, in this case the user's body. In one embodiment, device 24 projects a pattern of spots onto the object and captures an image of the projected pattern. Computer 26 then computes the 3D coordinates of points on the surface of the user's body by triangulation, based on transverse shifts of the spots in the pattern. Methods and devices for this sort of triangulation-based 3D mapping using a projected pattern are described, for example, in PCT International Publications WO 2007/043036, WO 2007/105205 and WO 2008/120217, whose disclosures are incorporated herein by reference. Alternatively, system 20 may use other methods of 3D mapping, using single or multiple cameras or other types of sensors, as are known in the art.

Computer 26 typically comprises a general-purpose computer processor, which is programmed in software to carry out the functions described hereinbelow. The software may be downloaded to the processor in electronic form, over a network, for example, or it may alternatively be provided on non-transitory tangible media, such as optical, magnetic, or electronic memory media. Alternatively or additionally, some or all of the functions of the image processor may be implemented in dedicated hardware, such as a custom or semi-custom integrated circuit or a programmable digital signal processor (DSP). Although computer 26 is shown in FIG. 1, by way of example, as a separate unit from sensing device 24, some or all of the processing functions of the computer may be performed by suitable dedicated circuitry within the housing of the sensing device or otherwise associated with the sensing device.

As another alternative, these processing functions may be carried out by a suitable processor that is integrated with display screen 28 (in a television set, for example) or with any other suitable sort of computerized device, such as a game console or media player. The sensing functions of device 24 may likewise be integrated into the computer or other computerized apparatus that is to be controlled by the sensor output.

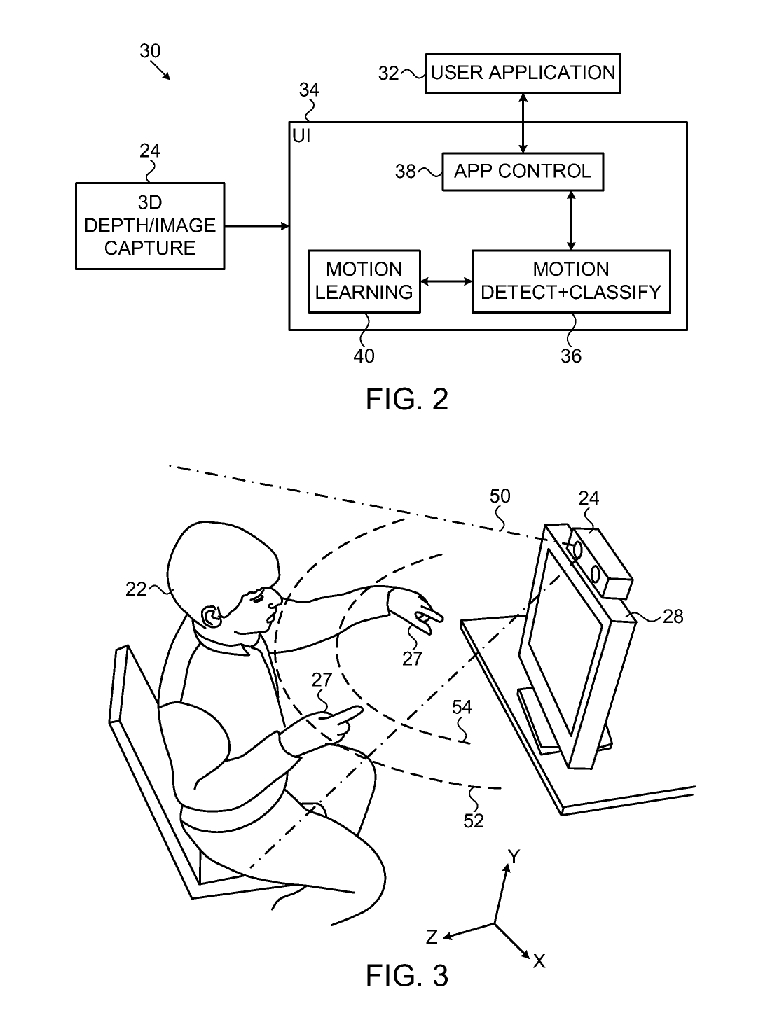

FIG. 2 is a block diagram that schematically illustrates a functional structure 30 of system 20, including functional components of a 3D user interface 34, in accordance with an embodiment of the present invention. The operation of these components is described in greater detail with reference to the figures that follow.

User interface 34 receives depth maps based on the data generated by device 24, as explained above. A motion detection and classification function 36 identifies parts of the user's body. It detects and tracks the motion of these body parts in order to decode and classify user gestures as the user interacts with display 28. A motion learning function 40 may be used to train the system to recognize particular gestures for subsequent classification. The detection and classification function outputs information regarding the location and/or velocity (speed and direction of motion) of detected body parts, and possibly decoded gestures, as well, to an application control function 38, which controls a user application 32 accordingly.

FIG. 3 is a schematic, pictorial illustration showing how user 22 may operate a “touchless touch screen” function of the 3D user interface in system 20, in accordance with an embodiment of the present invention. For the purpose of this illustration, the X-Y plane is taken to be parallel to the plane of display screen 28, with distance (depth) perpendicular to this plane corresponding to the Z-axis, and the origin located at device 24. The system creates a depth map of objects within a field of view 50 of device 24, including the parts of the user's body that are in the field of view.

The operation of 3D user interface 34 is based on an artificial division of the space within field of view 50 into a number of regions:
A visualization surface 52 defines the outer limit of a visualization region. Objects beyond this limit (such as the user's head in FIG. 3) are ignored by user interface 34. When a body part of the user is located within the visualization surface, the user interface detects it and provides visual feedback to the user regarding the location of that body part, typically in the form of an image or icon on display screen 28. In FIG. 3, both of the user's hands are in the visualization region.
An interaction surface 54, which is typically located within the visualization region, defines the outer limit of the interaction region. When a part of the user's body crosses the interaction surface, it can trigger control instructions to application 32 via application control function 38, as would occur, for instance, if the user made physical contact with an actual touch screen. In this case, however, no physical contact is required to trigger the action. In the example shown in FIG. 3, the user's left hand has crossed the interaction surface and may thus interact with application objects 29 presented on display 28.

The interaction and visualization surfaces may have any suitable shapes. For some applications, the inventors have found spherical surfaces to be convenient, as shown in FIG. 3. Alternatively, one or both of the surfaces may be planar.

Various methods may be used to determine when a body part has crossed interaction surface 54 and where it is located. For simple tasks, static analysis of the 3D locations of points in the depth map of the body part may be sufficient. Alternatively, dynamic, velocity-based detection may provide more timely, reliable results, including prediction of and adaptation to user gestures as they occur. Thus, when a part of the user's body moves toward the interaction surface for a sufficiently long time, it is assumed to be located within the interaction region and may, in turn, result in the application objects being moved, resized or rotated, or otherwise controlled depending on the motion of the body part.

Additionally or alternatively, the user may control the application objects by performing distinctive gestures, such as a “grabbing” or “pushing” motion over a given application object 29. The 3D user interface may be programmed to recognize these gestures only when they occur within the visualization or interaction region. Alternatively, the gesture-based interface may be independent of these predefined regions. In either case, the user trains the user interface by performing the required gestures. Motion learning function 40 tracks these training gestures, and is subsequently able to recognize and translate them into appropriate system interaction requests. Any suitable motion learning and classification method that is known in the art, such as Hidden Markov Models or Support Vector Machines, may be used for this purpose. Alternatively, other non-learning based techniques such as heuristic evaluation can be used for interpreting gestures performed by the user.

The use of interaction and visualization surfaces 54 and 52 enhances the reliability of the 3D user interface and reduces the likelihood of misinterpreting user motions that are not intended to invoke application commands. For instance, a circular palm motion may be recognized as an audio volume control action, but only when the gesture is made inside the interaction region. Thus, circular palm movements outside the interaction region will not inadvertently cause volume changes. Alternatively, the 3D user interface may recognize and respond to gestures outside the interaction region.

Analysis and recognition of user motions may be used for other purposes, such as interactive games. Techniques of this sort are described in the above-mentioned U.S. Provisional Patent Application 61/020,754. In one embodiment, user motion analysis is used to determine the speed, acceleration and direction of collision between a part of the user's body, or an object held by the user, and a predefined 3D shape in space. For example, the computer can control an interactive tennis game responsively to the direction and speed of the user's hand, as indicated by the captured depth maps. In other words, upon presenting a racket on the display, the computer may translate motion parameters, extracted over time, into certain racket motions (i.e., position the racket on the display responsively to the detected direction and speed of the user's hand), and may identify collisions between the “racket” and the location of a “ball.” The computer then changes and displays the direction and speed of motion of the ball accordingly.

Further additionally or alternatively, 3D user interface 34 may be configured to detect static postures, rather than only dynamic motion. For instance, the user interface may be trained to recognize the positions of the user's hands and the forms they create (such as “three fingers up” or “two fingers to the right” or “index finger forward”), and to generate application control outputs accordingly. Alternatively, other non-training based techniques such as heuristic evaluation can be used for recognizing the positions of the user's hands and the forms they create.

Similarly, the 3D user interface may use the posture of certain body parts (such as the upper body, arms, and/or head), or even of the entire body, as a sort of “human joystick” for interacting with games and other applications. In some embodiments, the computer may control a flight simulation of an object presented on the display responsively to the detected direction and speed of the user's body and/or limbs (i.e., gestures). Examples of an on-screen object that can be controlled responsively to the user's gestures include an inanimate object such as an airplane, and a digital representation of the user such as an avatar. In operation, the computer may extract the pitch, yaw and roll of the user's upper body and may use these parameters in controlling the flight simulation. Other applications will be apparent to those skilled in the art.

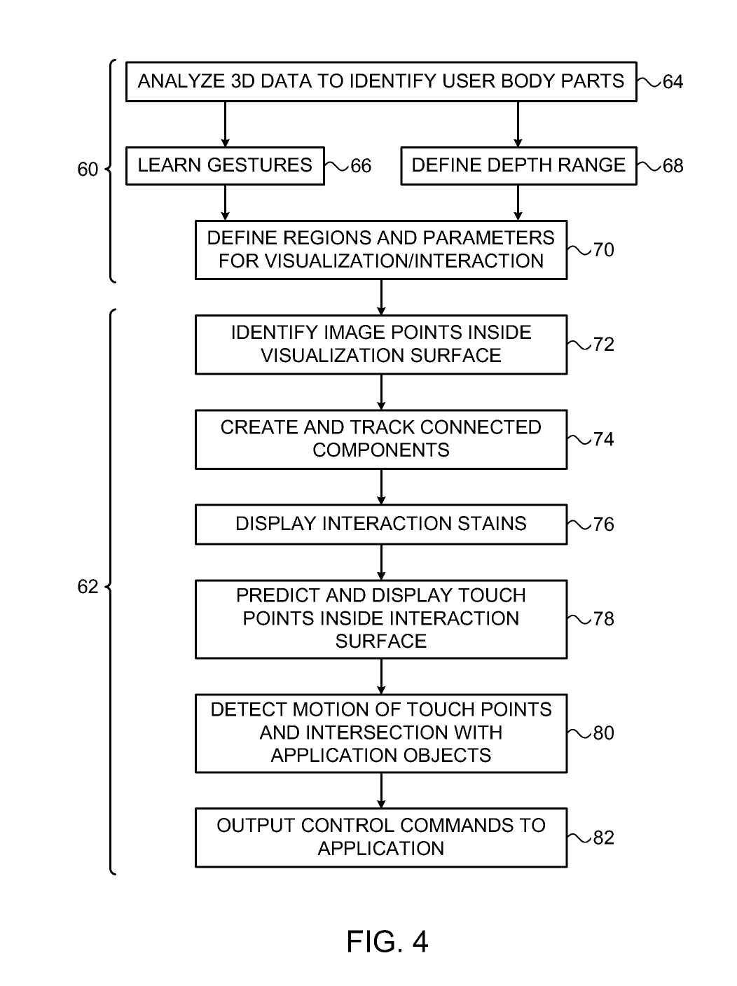

FIG. 4 is a flow chart that schematically illustrates a method for operation of 3D user interface 34, in accordance with an embodiment of the present invention. In this example, the operation is assumed to include a training phase 60, prior to an operational phase 62. During the training phase, the user positions himself (or herself) within field of view 50. Device 24 captures 3D data so as to generate 3D maps of the user's body. Computer 26 analyzes the 3D data in order to identify parts of the user's body that will be used in application control, in an identification step 64. Methods for performing this sort of analysis are described, for example, in PCT International Publication WO 2007/132451, whose disclosure is incorporated herein by reference. The 3D data may be used at this stage in learning user gestures and static postures, as described above, in a gesture learning step 66.

The user may also be prompted to define the limits of the visualization and interaction regions, at a range definition step 68. The user may specify not only the depth (Z) dimension of the visualization and interaction surfaces, but also the transverse (X-Y) dimensions of these regions, thus defining an area in space that corresponds to the area of display screen 28. In other words, when the user's hand is subsequently located inside the interaction surface at the upper-left corner of this region, it will interact with a given application object 29 positioned at the upper-left corner of the display screen, as though the user were touching that location on a touch screen.

Based on the results of steps 66 and 68, learning function 40 defines the regions and parameters to be used in subsequent application interaction, at a parameter definition step 70. The parameters typically include, inter alia, the locations of the visualization and interaction surfaces and, optionally, a zoom factor that maps the transverse dimensions of the visualization and interaction regions to the corresponding dimensions of the display screen.

During operational phase 62, computer 26 receives a stream of depth data from device 24 at a regular frame rate, such as thirty frames/sec. For each frame, the computer finds the geometrical intersection of the 3D depth data with the visualization surface, and thus extracts the set of points that are inside the visualization region, at an image identification step 72. This set of points is provided as input to a 3D connected component analysis algorithm (CCAA), at an analysis step 74. The algorithm detects sets of pixels that are within a predefined distance of their neighboring pixels in terms of X, Y and Z distance. The output of the CCAA is a set of such connected component shapes, wherein each pixel within the visualization plane is labeled with a number denoting the connected component to which it belongs. Connected components that are smaller than some predefined threshold, in terms of the number of pixels within the component, are discarded.

CCAA techniques are commonly used in 2D image analysis, but changes in the algorithm are required in order to handle 3D map data. A detailed method for 3D CCAA is presented in the Appendix below. This kind of analysis reduces the depth information obtained from device 24 into a much simpler set of objects, which can then be used to identify the parts of the body of a human user in the scene, as well as performing other analyses of the scene content.

Computer 26 tracks the connected components over time. For each pair of consecutive frames, the computer matches the components identified in the first frame with the components identified in the second frame, and thus provides time-persistent identification of the connected components. Labeled and tracked connected components, referred to herein as “interaction stains,” are displayed on screen 28, at a display step 76. This display provides user 22 with visual feedback regarding the locations of the interaction stains even before there is actual interaction with application objects 29. Typically, the computer also measures and tracks the velocities of the moving interaction stains in the Z-direction, and possibly in the X-Y plane, as well.

Computer 26 detects any penetration of the interaction surface by any of the interaction stains, and identifies the penetration locations as “touch points,” at a penetration detection step 78. Each touch point may be represented by the center of mass of the corresponding stain, or by any other representative point, in accordance with application requirements. The touch points may be shown on display 28 in various ways, for example:
As a “static” shape, such as a circle at the location of each touch point;
As an outline of the shape of the user's body part (such as the hand) that is creating the interaction stain, using an edge detection algorithm followed by an edge stabilization filter;
As a color video representation of the user's body part.

Furthermore, the visual representation of the interaction stains may be augmented by audible feedback (such as a “click” each time an interaction stain penetrates the visualization or the interaction surface). Additionally or alternatively, computer 26 may generate a visual indication of the distance of the interaction stain from the visualization surface, thus enabling the user to predict the timing of the actual touch.

Further additionally or alternatively, the computer may use the above-mentioned velocity measurement to predict the appearance and motion of these touch points. Penetration of the interaction plane is thus detected when any interaction stain is in motion in the appropriate direction for a long enough period of time, depending on the time and distance parameters defined at step 70.

Optionally, computer 26 applies a smoothing filter to stabilize the location of the touch point on display screen 28. This filter reduces or eliminates random small-amplitude motion around the location of the touch point that may result from noise or other interference. The smoothing filter may use a simple average applied over time, such as the last N frames (wherein N is selected empirically and is typically in range of 10-20 frames). Alternatively, a prediction-based filter can be used to extrapolate the motion of the interaction stain. The measured speed of motion of the interaction stain may be combined with a prediction filter to give different weights to the predicted location of the interaction stain and the actual measured location in the current frame.

Computer 26 checks the touch points identified at step 78 against the locations of application objects 29, at an intersection checking step 80. Typically, when a touch point intersects with a given application object 29, it selects or activates the given application object, in a manner analogous to touching an object on a touch screen.

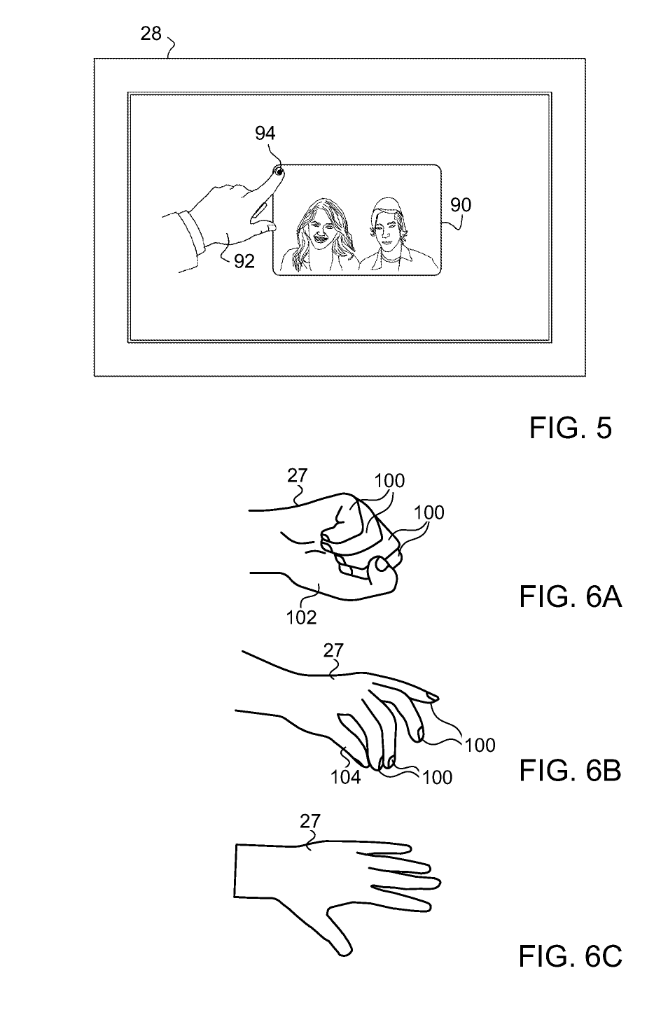

FIG. 5 is a schematic representation of display screen 28, showing images created on the screen by the method described above, in accordance with an embodiment of the present invention. In this example, application 32 is a picture album application, in which the given application object to be manipulated by the user is a photo image 90. An interaction stain 92 represents the user's hand. A touch point 94 represents the user's index finger, which has penetrated the interaction surface. (Although only a single touch point is shown in this figure for the sake of simplicity, in practice there may be multiple touch points, as well as multiple interaction stains.) When an active touch point is located within the boundary of photo image 90, as shown in the figure, the photo image may “stick” itself to the touch point and will then move as the user moves the touch point. When two touch points (corresponding to two of the user's fingers, for example) intersect with a photo image, their motion may be translated into a resize and/or rotate operation to be applied to the photo image.

Additionally or alternatively, a user gesture, such as a Grab, a Push, or a Pull may be required to verify the user's intention to activate a given application object 29. Computer 26 may recognize simple hand gestures by applying a motion detection algorithm to one or more interaction stains located within the interaction region or the visualization region. For example, the computer may keep a record of the position of each stain record over the past N frames, wherein N is defined empirically and depends on the actual length of the required gesture. (With a 3D sensor providing depth information at 30 frames per second, N=10 gives good results for short, simple gestures.) Based on the location history of each interaction stain, the computer finds the direction and speed of motion using any suitable fitting method, such as least-squares linear regression. The speed of motion may be calculated using timing information from any source, such as the computer's internal clock or a time stamp attached to each frame of depth data, together with measurement of the distance of motion of the interaction stain.

Returning now to FIG. 4, computer 26 generates control commands for the current application based on the interaction of the touch points with application objects 29, as well as any appropriate gestures, at a control output step 82. The computer may associate each direction of movement of a touch point with a respective action, depending on application requirements. For example, in a media player application, “left” and “right” movements of the touch point may be used to control channels, while “up” and “down” control volume. Other applications may use the speed of motion for more advanced functions, such as “fast down” for “mute” in media control, and “fast up” for “cancel.”

More complex gestures may be detected using shape matching. Thus “clockwise circle” and “counterclockwise circle” may be used for volume control, for example. (Circular motion may be detected by applying a minimum-least-square-error or other fitting method to each point on the motion trajectory of the touch point with respect to the center of the circle that is defined by the center of the minimal bounding box containing all the trajectory points.) Other types of shape learning and classification may use shape segment curvature measurement as a set of features for a Support Vector Machine computation or for other methods of classification that are known in the art.

As described supra, computer 26 may process a sequence of captured depth maps indicating that user 22 is performing a Grab gesture, a Push gesture, or a Pull gesture. Computer 26 can then control a software application executing on the computer responsively to these gestures. The Grab gesture, the Pull gesture and the Push gesture are also referred to herein as engagement gestures.

In some embodiments, as user 22 points hand 27 toward a given application object 29 and performs one of the engagement gestures described hereinabove, computer 26 may perform an operation associated with the given application object. For example, the given application object may comprise an icon for a movie, and computer may execute an application that presents a preview of the movie in response to the engagement gesture.

FIG. 6A is a schematic pictorial illustration of a first example of user 22 performing a Grab gesture by closing hand 27 to make a fist. Alternatively, the Grab gesture may comprise user 22 folding one or more fingers 100 toward a palm 102.

FIG. 6B is a schematic pictorial illustration of a second example of user 22 performing a Grab gesture by pinching together two or more fingers 100 with a thumb 104. The example in FIG. 6B shows user 22 pinching thumb 104 with the index finger and the middle finger of hand 27.

FIG. 6C is a schematic pictorial illustration of hand 27 relaxing hand 27 to perform a Release gesture, so as to open the hand from its closed or folded state, thereby concluding the Grab gesture. In response to identifying the Release gesture, computer 26 may end the operation started upon detecting the Grab gesture. Continuing the example described supra, computer 26 can end the movie preview operation upon detecting the Release gesture.

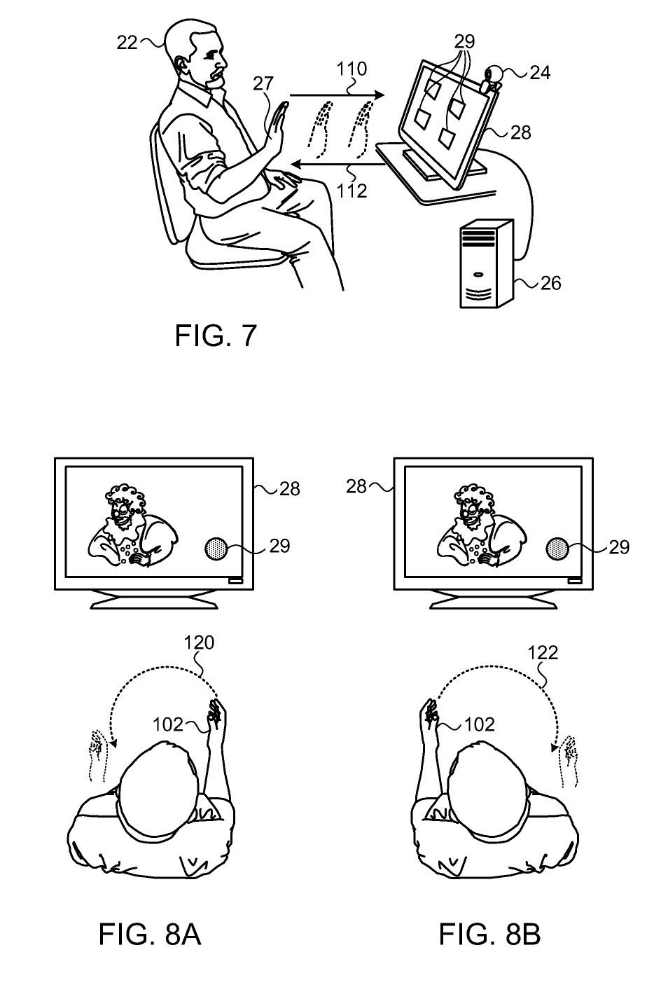

FIG. 7 is a schematic pictorial illustration of a user performing the Pull gesture and the Push gesture, in accordance with an embodiment of the present invention. In the example shown in the Figure, user 22 can perform the Push gesture by moving hand 27 toward a given application object 29 in a motion indicated by an arrow 110. Likewise, user 22 can perform the Pull gesture by moving hand 27 away from the given application object in a motion indicated by an arrow 112.

As described supra, computer 26 may process a sequence of captured depth maps indicating that user 22 moves a body part (e.g., palm 102) in a circular motion. Computer 26 can then control a software application executing on the computer responsively to the detected circular motion of the body part.

FIGS. 8A and 8B, are pictorial illustrations of the user performing a circular motion with palm 102, in accordance with an embodiment of the present invention. In FIG. 8A, user 22 is moving palm 102 in a counterclockwise direction indicated by an arrow 120, and in FIG. 8B, user 22 is moving the palm in a clockwise direction indicated by an arrow 122. Typically, the clockwise and the counterclockwise directions comprise user 22 moving hand 27, and thus palm 102, in a vertical plane. In some embodiments, user 22 may position hand 27 so that palm 102 is in the vertical plane.

Upon detecting user 22 moving palm 102 in a circular motion, computer 26 can rotate a given application object 29 in the direction of the gesture, and perform an operation associated with rotating the given application object. In the example shown in FIGS. 8A and 8B, the given application object comprises a knob icon, and computer 26 can rotate the knob icon responsively to the circular motion of palm 102 For example, if the knob icon controls a user interface parameter such as a volume level, then user 22 can increase the volume level by pointing hand 27 in the direction of the knob icon and moving palm 102 in a clockwise circular motion. Likewise, user 22 can decrease the volume level by pointing hand 27 in the direction of the knob icon and moving palm 102 in a counterclockwise circular motion.

Although certain embodiments of the present invention are described above in the context of a particular hardware configuration and interaction environment, as shown in FIG. 1, the principles of the present invention may similarly be applied in other types of 3D sensing and control systems, for a wide range of different applications. The terms “computer” “software application,” and “computer application,” as used in the present patent application and in the claims, should therefore be understood broadly to refer to any sort of computerized device and functionality of the device that may be controlled by a user.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### Appendix—3D Connected Component (3DCC) Analysis

In an embodiment of the present invention, the definition of a 3DCC is as follows:
Two 3D points are said to be D-connected to each other if their projections on the XY plane are located next to each other, and their depth values differ by no more than a given threshold D_TH.
Given two 3D points P and Q, there is said to be a D-connected path between them if there exists a set of 3D points (P, p1, p2, . . . pN, Q) such that each two consecutive points in the list are D-connected to each other.
A set of 3D points is said to be D-connected if any two points within it have a D-connected path between them.
A D-connected set of 3D points is said to be maximally D-connected if for each point p within the set, no neighbor of p in the XY plane can be added to the set without breaking the connectivity condition.

In one embodiment of the present invention, the 3DCCA algorithm finds maximally D-connected components as follows:
1. Allocate a label value for each pixel, denoted by LABEL(x,y) for the pixel located at (x,y).
2. Define a depth threshold D_TH.
3. Define a queue (first in-first out) data structure, denoted by QUEUE.
4. Set LABEL(x,y) to be −1 for all x,y.
5. Set cur_label to be 1.
6. START: Find the next pixel p_start whose LABEL is −1. If there are no more such pixels, stop.
7. Set LABEL(p_start) to be cur_label and increment cur_label by one.
8. Insert the pixel p_start into QUEUE.
9. While the QUEUE is not empty, repeat the following steps:
   a. Remove the head item (p_head=x,y) from the queue.
   b. For each neighbor N of p_head:
      i. if LABEL(N) is >0 skip to the next neighbor.
      ii. if the depth value of N differs from the depth value of p_head by no more than D_TH, add p_head to the queue and set LABEL(p_head) to be cur_label.
10. Goto START

In the above algorithm, the neighbors of a pixel (x,y) are taken to be the pixels with the following coordinates: (x−1, y−1), (x−1, y), (x−1, y+1), (x, y−1), (x, y+1), (x+1, y−1), (x+1, y), (x+1, y+1). Neighbors with coordinates outside the bitmap (negative or larger than the bitmap resolution) are not taken into consideration.

Performance of the above algorithm may be improved by reducing the number of memory access operations that are required. One method for enhancing performance in this way includes the following modifications:
Another data structure BLOBS is maintained, as a one-dimensional array of labels. This data structure represents the lower parts of all connected components discovered in the previous iteration. BLOBS is initialized to an empty set.
In step 9b above, instead of checking all neighbors of each pixel, only the left and right neighbors are checked.
In an additional step 9c, the depth differences between neighboring values in the BLOBS structure are checked, in place of checking the original upper and lower neighbors of each pixel in the depth map.

1. A method, comprising:
defining an interaction surface containing an interaction region in space;
capturing a sequence of depth maps over time of at least a part of a body of a human subject;
processing the depth maps in order to detect a direction and speed of movement of the part of the body as the part of the body passes through the interaction region; and
controlling a software application, selected from a group of software applications consisting of a flight simulation and an interactive tennis game, responsively to the detected direction and speed.

2. The method according to claim 1, wherein the software application comprises the interactive tennis game.

3. The method according to claim 2, wherein controlling the interactive tennis game comprises presenting a racket on a display, and positioning the racket on the display responsively to the detected direction and speed.

4. The method according to claim 1, wherein the software application comprises the flight simulation.

5. The method according to claim 4, wherein controlling the flight simulation comprises extracting pitch parameters, yaw parameters and roll parameters from the detected direction and speed, and applying the extracted parameters in the flight simulation.

6. An apparatus, comprising:
a display; and
a computer coupled to the display and configured to define an interaction surface containing an interaction region in space, to capture a sequence of depth maps over time of at least a part of a body of a human subject, to process the depth maps in order to detect a direction and speed of movement of the part of the body as the part of the body passes through the interaction region, and to control a software application, selected from a group of software applications consisting of a flight simulation and an interactive tennis game, responsively to the detected direction and speed.

7. The apparatus according to claim 6, wherein the software application comprises the interactive tennis game

8. The apparatus according to claim 7, wherein the computer is configured to control the interactive tennis game by presenting a racket on a display, and positioning the racket on the display responsively to the detected direction and speed.

9. The apparatus according to claim 6, wherein the software application comprises the flight simulation.

10. The apparatus according to claim 9, wherein the computer is configured to control the flight simulation by extracting pitch parameters, yaw parameters and roll parameters from the detected direction and speed, and applying the extracted parameters in the flight simulation.

11. A computer software product comprising a non-transitory computer-readable medium, in which program instructions are stored, which instructions, when read by a computer, cause the computer to define an interaction surface containing an interaction region in space, to capture a sequence of depth maps over time of at least a part of a body of a human subject, to process the depth maps in order to detect a direction and speed of movement of the part of the body as the part of the body passes through the interaction region, and to control a software application, selected from a group of software applications consisting of a flight simulation and an interactive tennis game, responsively to the detected direction and speed.
